(19) United States
(12) Patent Application Publication
(10) Pub. No.: US 2021/0235909 A1
(43) Pub. Date: Aug. 5, 2021

(54) RELEASABLE HANGER FOR FRUIT

(71) Applicant: Ashvini K. Reddy, Baltimore, MD (US)

(72) Inventor: Ashvini K. Reddy, Baltimore, MD (US)

(21) Appl. No.: 16/782,523

(22) Filed: Feb. 5, 2020

(51) Int. Cl. A47G 23/00; F16M 13/02

(52) U.S. Cl. CPC A47G 23/00; F16M 13/022

(57) ABSTRACT

A bracket assembly having an upper leg and a lower leg for releasably and nondestructively engaging a shelf is provided. A spacer portion interconnects the upper leg and the lower leg, wherein at least one of the upper leg, the lower leg and spacer portion is configured to exert a clamping force on the shelf. A hook assembly extends from the lower leg and is configurated to retain produce such as bananas during ripening.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A “SEQUENCE LISTING”

Not applicable.

### BACKGROUND OF THE INVENTION

### Field of the Invention

The present disclosure relates to an apparatus and method for storing produce and particularly to an apparatus and method for suspending produce and particularly to an apparatus and method for suspending bananas during ripening.

### Description of Related Art

Bananas are one of the most popular fruits, botanically a berry, in the world. Commercial bananas are grown in temperate climates and thus must be transported to markets outside such climates. The harvesting and ripening process for bananas is a heavily time and chemical dependent process. Even the storage of bananas by the consumer can have material impact on the timing and quality of the product.

The hanging of bananas has been found to enhance the quality of the resulting product. However, hanging bananas either requires a stand for supporting the suspended bananas, thereby occupying valuable counter space or brackets have been screwed into or bonded to cabinets or walls which permanently mar the cabinet.

Therefore, the need exists for a method and apparatus for suspending bananas without requiring countertop space or defacing existing cabinetry.

### BRIEF SUMMARY OF THE INVENTION

The present system provides a bracket assembly for releasably engaging a shelf having a top surface and a bottom surface, wherein the bracket assembly includes an elongate upper leg configured to contact the top surface; a lower leg configured to contact the bottom surface; a spacer portion interconnecting the upper leg and the lower leg; the spacer portion separating the upper leg and the lower leg by a distance sized to receive a portion of the shelf between the upper leg and the lower leg; and a hook assembly depending from the lower leg, wherein the hook assembly includes a hook.

The disclosure provides a method for engaging fruit, such as but not limited to suspending ripening fruit, wherein the method includes disposing an upper leg of a bracket assembly to releasably engage a top surface of the shelf; disposing a lower leg of the bracket assembly to releasably engage a bottom surface of the shelf to releasably engage the bracket assembly with the shelf, wherein a spacer portion interconnects the lower leg and the upper leg; and engaging the fruit with a hook assembly extending from the bracket assembly.

### BRIEF DESCRIPTION OF THE SEVERAL VIEWS OF THE DRAWING(S)

FIG. 1 is a side elevational of a first configuration of the bracket assembly.

FIG. 2 is a side elevational of a second configuration of the bracket assembly.

FIG. 3 is a side elevational of a third configuration of the bracket assembly.

FIG. 4 is a side elevational of a fourth configuration of the bracket assembly.

FIG. 5 is a side elevational of a fifth configuration of the bracket assembly.

### DETAILED DESCRIPTION OF THE INVENTION

Referring to the Figures, the present system provides a bracket assembly 10 for hanging an object, such as fruit for ripening.

The bracket assembly 10 is configured to releasably engage a shelf 20 having a top surface 22, a bottom surface 24 and a free edge 26 interconnecting the top surface and the bottom surface. In one configuration, the top surface 22 and the bottom surface 24 are planar and spaced by a perpendicular free edge 26.

The bracket assembly 10 includes an upper leg 30, a lower leg 40, a spacer portion 50 interconnecting the upper leg and the lower leg, and a hook assembly 60. Thus, in one configuration, the bracket assembly 10 has a closed end 14 defined by the spacer portion 50, wherein the upper leg 30 and the lower leg 40 project from the spacer portion to terminate a respective free ends 32, 42. The upper leg 30 has a length extending from the spacer portion 50 to the upper leg free end 32 and the lower leg 40 has a length extending from the spacer to the lower leg free end 42.

In one configuration, the upper leg 30 is a substantiality planar elongate member extending from the spacer portion 50 to terminate at the free end 32. The upper leg 30 can have a rectangular footprint having parallel long edges 44, 46 extending from a connection to the spacer portion 50 and terminating at the free end 32. However, it is understood the upper leg 30 can define a variety of footprint profiles.

In one configuration, the upper leg 30 has a uniform thickness, wherein the thickness is selected to minimize tipping of any item supported by the shelf 20 that may at least partly rest upon the upper leg. At least partly depending upon the material of the upper leg 30, the upper leg can have a thickness less than ⅛ inch and in further configurations less than 1/16 inch and in further configurations less than 1/32 inch.

In one configuration, the shelf 20 may be located in a cabinet having an inset door which closes within the frame of the cabinet. Thus, there is a gap between the bottom of the inset door and the top 22 of the bottom shelf 20. The upper leg 30 is configured to fit within such gap.

The upper leg 30 has a sufficient length, in conjunction with the lower leg 40 and the spacer portion 50 to preclude rotation about the free edge 26 of the shelf 20 or separation from the top 22 of the shelf.

The spacer portion 50 is generally sized to accommodate a thickness of the shelf 20. Depending on the method of manufacture, the spacer portion 50 can be a planar element and extend perpendicular to the upper leg 30 and the lower leg 40. It is contemplated the spacer portion 50 can be curvilinear or arcuate to accommodate a shape of the free edge 26 of the shelf 20 or as dictated by manufacturing considerations.

In a further configuration, the spacer portion 50 can provide a bias or resilience to the upper leg 30 and/or the lower leg 30, wherein the upper leg and the lower leg are moveable between proximal position and a distal position. That is, the hanger assembly 10 can exert a clamping force on the shelf 20.

In one configuration, the spacer portion 50 has the same width as the upper leg 30 and the lower leg 40. However, it is understood the spacer portion 50 can have a different width than the upper leg and the lower leg. Further, as partly dictated by the manufacturing process, the spacer portion 50 can have the same thickness as the upper leg 30 and the lower leg 40.

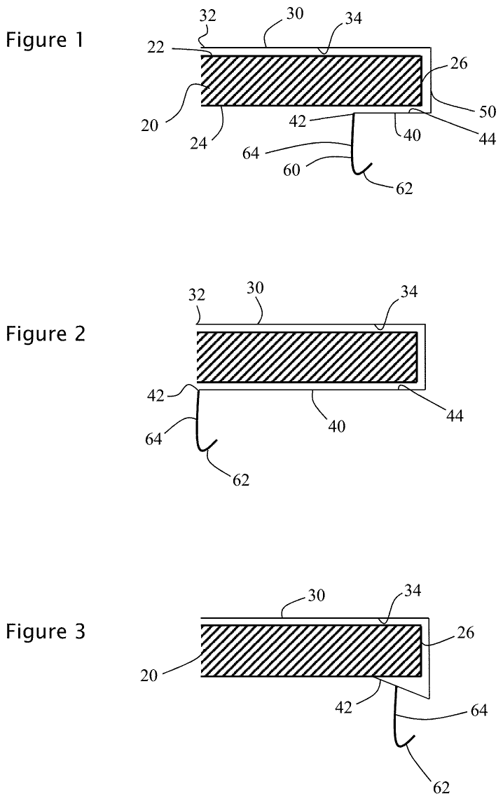

As seen in FIGS. 1 and 2, in one configuration, the upper leg 30 is parallel to the lower leg 40 and the spacer potion 50 is perpendicular to the upper leg and the lower leg.

The hook assembly 60 includes at least a hook 62. The term hook is curved or bent back at an angle, for catching hold of or hanging the selected produce, such as bananas. The hook 62 can extend directly from the lower leg.

In a further configuration, the hook assembly 60 includes standoff 64 intermediate the hook 62 and the lower leg 40, wherein the standoff distances the hook from the lower leg. The standoff 64 can extend perpendicular from the lower leg 40 or can be inclined from the lower leg. The standoff 64 can have the same width and thickness as the lower leg 40 and the hook 62, or can define a separate cross section. It is further contemplated, the standoff 64 can be resilient between a loaded configuration supporting the fruit such as bananas and an unloaded position free of the weight of the fruit such as bananas.

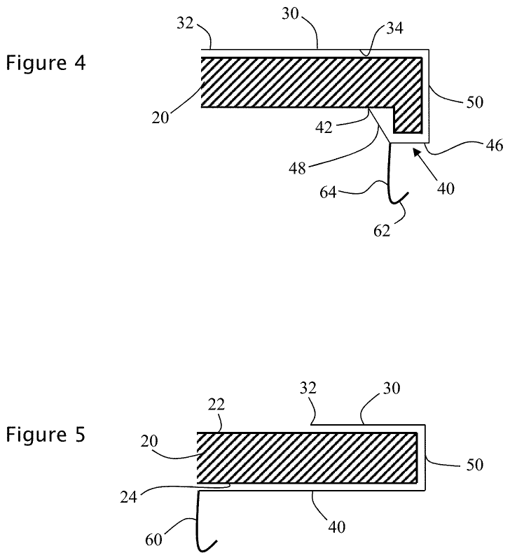

Referring to FIGS. 1 and 2, the hook assembly 60 can extend from the free end 42 of the lower leg 40. As seen in FIGS. 3 and 4, in further configurations, the hook assembly 60 extends from the lower leg 40 intermediate the spacer portion 50 and the lower leg free end 42.

Although the hook 62 is shown as being barbless, it is understood the hook can include a rounded barb for reducing unintended separation of the fruit such as bananas from the bracket assembly 10.

Referring to FIG. 4, if the cabinet does not include a door, but includes a frame, then the upper leg 30 and the lower leg 40 may not be parallel, but rather the lower leg may be inclined toward the upper leg so as to accommodate a portion of the frame that can project downward from the edge 26 of the shelf 20. In this construction, the lower leg 40 can include a set off length 46 and an inclined length 48, wherein the setoff length is sized to extend the thickness of the depending cabinet frame. The inclined length 48 then extends from the setoff length to contact the bottom 24 of the shelf 20.

As seen in FIG. 2, in a further configuration of a cabinet having a frame, the bracket assembly 10 may engage the shelf 20 within the cabinet rather than the bottom of the cabinet. In this configuration, the lower leg 40 extends a sufficient distance from the spacing portion 50 so that the fruit, such as a bunch of bananas can be suspended by the hook assembly 60 entirely within the cabinet, as the cabinet door is closed with the suspended bananas entirely within the cabinet.

Referring to FIGS. 3 and 4, the upper leg 30 can have a length greater than the lower leg 40. In further configurations, the upper leg 30 is at least 2 times longer than the lower leg 40 and in a further configuration at least 3 times longer than the lower leg. However, as seen in FIG. 5, the lower leg 40 can be longer than the upper leg 30, and in further configurations the lower leg is at least 2 times longer than the upper leg and in a further configuration at least 3 times longer than the upper leg.

Referring to the Figures, it is contemplated that at least a majority, and in further configurations the entirety of the length of the upper leg 30 contacts the top surface 24 of the shelf 20.

The upper leg 30 includes an upper leg contact surface 34 which, upon operable engagement of the bracket assembly 10 and the shelf 20 contacts the top surface 22 of the shelf. Similarly, the lower leg 40 includes a lower leg contact surface 44 which, upon operable engagement of the bracket assembly 10 and the shelf 20 contacts the bottom surface 24 of the shelf 20. The upper leg contact surface 34 and lower leg contact surface 44 can be the same material as the remainder of the respective leg or can be a different material defining the interface with the shelf 20. In one configuration, at least one of the upper leg contact surface 34 and the lower leg contact surface 44 can be defined by a resilient material such as but not limited to elastomeric or polymeric which provides a grip to reduce friction between the shelf 20 and the bracket assembly 10.

In operation, the bracket assembly 10 is slid over the edge 26 of the shelf 20 to locate the spacer portion 50 proximal to the edge. Depending on the specific configuration of the shelf 20 and the bracket assembly 10, the upper leg 30 contacts the top surface 22 and the lower leg 40 contacts the lower surface 24. As seen in FIGS. 1 and 2, the entire length of the respective upper leg 30 and the lower leg 40 contacts the respective top surface 22 and bottom surface 24 of the shelf 20.

That is, the bracket assembly 10 releasably engages the shelf 20 free of secondary fasteners. The releasable engagement of the bracket assembly 10 and the shelf 20 is independent or free of any adhesive or chemical connection and is free of a destruction or deformation of the shelf. The bracket assembly 10 nondestructively and releasably engages the shelf 20.

Thus, the fruit can be engaged with the bracket assembly 10, for ripening, suspending, hanging, storage or any other function.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

1. A bracket assembly for releasably engaging a shelf having a top surface and a bottom surface, the bracket assembly comprising:
(a) an elongate upper leg configured to contact the top surface;
(b) a lower leg configured to contact the bottom surface;
(c) a spacer portion interconnecting the upper leg and the lower leg; the spacer portion separating the upper leg and the lower leg by a distance sized to receive a portion of the shelf between the upper leg and the lower leg; and
(d) a hook assembly depending from the lower leg, wherein the hook assembly includes a hook.

2. The bracket assembly of claim 1, wherein the spacer portion is planar and perpendicular to the upper leg.

3. The bracket assembly of claim 1, wherein the spacer portion is curvilinear.

4. The bracket assembly of claim 1, wherein a length of the spacer portion is adjustable.

5. The bracket assembly of claim 1, wherein the lower leg is parallel to the upper leg.

6. The bracket assembly of claim 1, wherein the lower leg is elongate and parallel to the upper leg.

7. The bracket assembly of claim 1, wherein the upper leg is planar.

8. The bracket assembly of claim 1, wherein the lower leg is configured to engage a bottom of the shelf to preclude rotation of the upper leg about the shelf.

9. The bracket assembly of claim 1, wherein the upper leg, the lower leg and the spacer portion are moveable between a contracted configuration and an expanded configuration.

10. The bracket assembly of claim 1, wherein at least one of the upper leg, the lower leg and the spacer portion is resilient.

11. The bracket assembly of claim 1, wherein the hook is curvilinear.

12. The bracket assembly of claim 1, wherein the hook includes a vertex.

13. The bracket assembly of claim 1, wherein the upper leg includes an upper leg contact surface, wherein the upper leg contact surface is formed of a different material than the upper leg.

14. The bracket assembly of claim 1, wherein the lower leg includes a lower leg contact surface, wherein the lower leg contact surface is formed of a different material than the lower leg.

15. The bracket assembly of claim 1, wherein the upper leg is longer than the lower leg.

16. The bracket assembly of claim 1, further comprising fruit engaged with the hook.

17. A method for engaging fruit, the method comprising:
(a) disposing an upper leg of a bracket assembly to releasably engage a top surface of the shelf;
(b) disposing a lower leg of the bracket assembly to releasably engage a bottom surface of the shelf to releasably engage the bracket assembly with the shelf, wherein a spacer portion interconnects the lower leg and the upper leg; and
(c) engaging fruit with a hook assembly extending from the bracket assembly.

18. The method of claim 17, further comprising biasing the lower leg toward the upper leg upon releasably engaging the shelf.
